(19) United States
(12) Patent Application Publication
(10) Pub. No.: US 2020/0116328 A1
(43) Pub. Date: Apr. 16, 2020

(54) LAMP COVER

(71) Applicant: T.Y.C. BROTHER INDUSTRIAL CO., LTD., Tainan City (TW)

(72) Inventors: Min-Feng LIN, Tainan City (TW); Nan-Ming LIN, Kaohsiung City (TW)

(73) Assignee: T.Y.C. BROTHER INDUSTRIAL CO., LTD., Tainan City (TW)

(21) Appl. No.: 16/406,351

(22) Filed: May 8, 2019

(30) Foreign Application Priority Data
Oct. 16, 2018 (TW) 107136372

(51) Int. Cl. F21S 45/60; F21S 41/43; F21V 1/14

(52) U.S. Cl. CPC F21S 45/60; F21V 1/14; F21S 41/43

(57) ABSTRACT

A lamp cover adapted for mounting to a vehicle lamp having an optical axis includes a light-transmissible cover body, an electrically-conductive film being light-transmissible and being formed on the cover body, and an electrode unit being electrically connected to the electrically-conductive film. The electrically-conductive film is adapted for converting electrical energy provided by the electrode unit into thermal energy to heat the cover body.

### CROSS-REFERENCE TO RELATED APPLICATION

This application claims priority of Taiwanese Invention Patent Application No. 107136372, filed on Oct. 16, 2018.

### FIELD

The disclosure relates to a lamp cover, more particularly to a lamp cover with an improved snow melting capability.

### BACKGROUND

In snowy days, other than roads and roofs of buildings, snows may also cover over vehicles, accumulating outside of vehicle lamp covers such that lighting and warning functions of the vehicle lamp are affected. Referring to FIGS. 1 and 2, a conventional lamp cover device 1 is adapted for installing on a lamp seat of a vehicle lamp and disposed in front of a light source of the vehicle lamp. The lamp cover device 1 includes a transparent lamp cover 11 made of a plastic material, and a heating unit 12 disposed on the lamp cover 11. The lamp cover 11 has opposite first and second surfaces 111, 112 and is convex relative to the lamp seat. The heating unit 12 includes a wire module 121 disposed on the first surface 111 facing the lamp seat. When the second surface 112 is covered in snow or ice that affects the lighting or warning function of the vehicle lamp, current may be passed through the wire module 121 and converted to heat energy in order to warm the lamp cover 11 and melt the snow and ice, restoring the vehicle lamp to normal functionalities.

However, in order to mitigate effects that the wire module 121 would have on a light pattern projected by the light source, the light source would have to be redesigned in correspondence with various arrangements of the wire module 121, which may cause inconvenience.

### SUMMARY

Therefore, the object of the disclosure is to provide a lamp cover that can alleviate the drawback of the prior art.

According to the disclosure, the lamp cover is adapted for mounting to a vehicle lamp having an optical axis, and includes a light-transmissible cover body, an electrically-conductive film that is light transmissible and that is formed on the cover body, and an electrode unit that is electrically connected to the electrically-conductive film.

The electrically-conductive film is adapted for converting electrical energy provided by the electrode unit into thermal energy to heat the cover body.

### BRIEF DESCRIPTION OF THE DRAWINGS

Other features and advantages of the disclosure will become apparent in the following detailed description of the embodiment with reference to the accompanying drawings, of which:

FIG. 1 is a top view of a conventional lamp cover device;

FIG. 2 is a sectional view taken along line II-II in FIG. 1 of the conventional lamp cover device;

FIG. 3 is a tope view of an embodiment of a lamp cover according to the disclosure;

FIG. 4 is a fragmentary sectional view taken along line IV-IV, illustrating a layered structure of the embodiment;

FIG. 5 is a schematic view taken along an optical axis of a vehicle lamp, illustrating the embodiment installed on a lamp seat and a light source of the vehicle lamp;

FIG. 6 is a process diagram illustrating consecutive steps of a method of producing the embodiment;

FIG. 7 is a top view illustrating an electrically-conductive film forming step of the method;

FIG. 8 is a top view of an intermediate product obtained after the electrically-conductive film forming step;

FIG. 9 is a top view illustrating an electrode unit forming step of the method performing on the intermediate product of FIG. 8;

FIG. 10 is a top view illustrating an electrode unit formed on the intermediate product;

FIG. 11 is a top view illustrating a protective layer forming step of the method covering a portion of the electrode unit;

FIG. 12 is a top view illustrating the embodiment produced by the method;

FIG. 13 is a heat zone image illustrating a thermal distribution of the embodiment after being energized and reaching equilibrium;

FIG. 14 is a graph illustrating how temperature of a main film portion of the embodiment varied over time;

and

FIG. 15 is a graph illustrating relationship between thickness and sheet resistance of an electrically-conductive film of the embodiment.

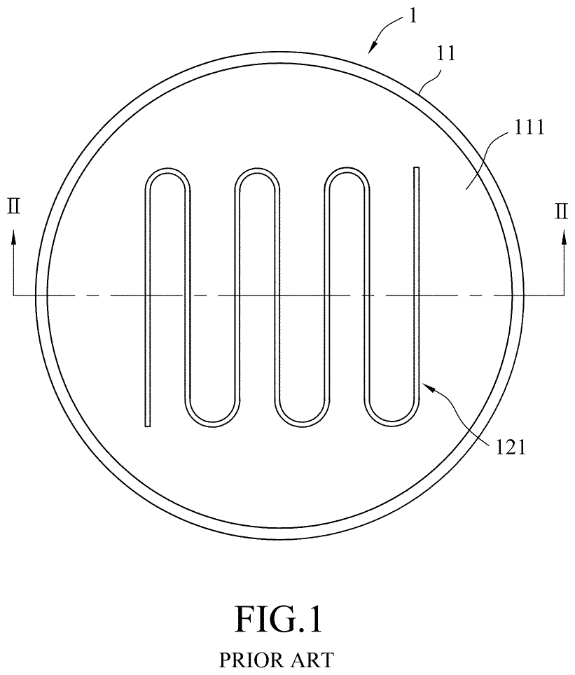

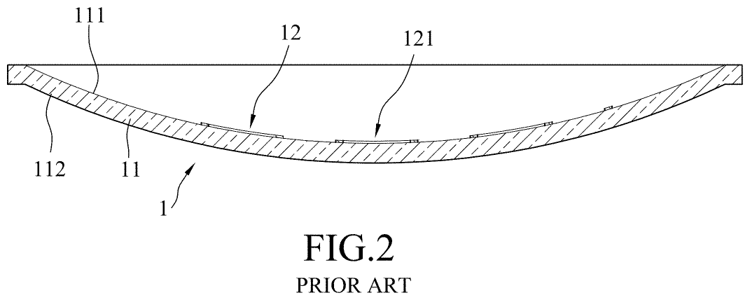

### DETAILED DESCRIPTION

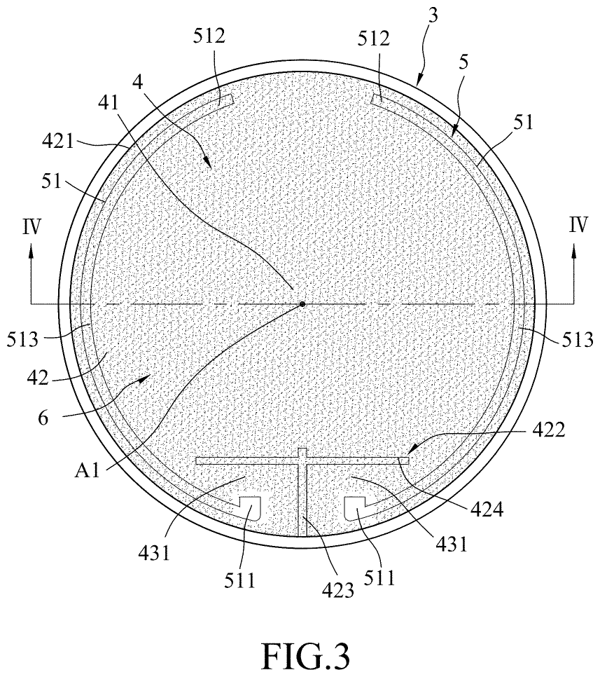

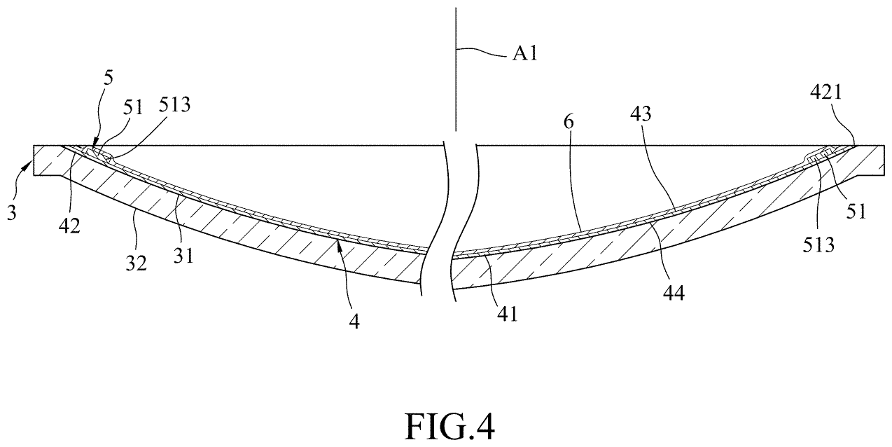

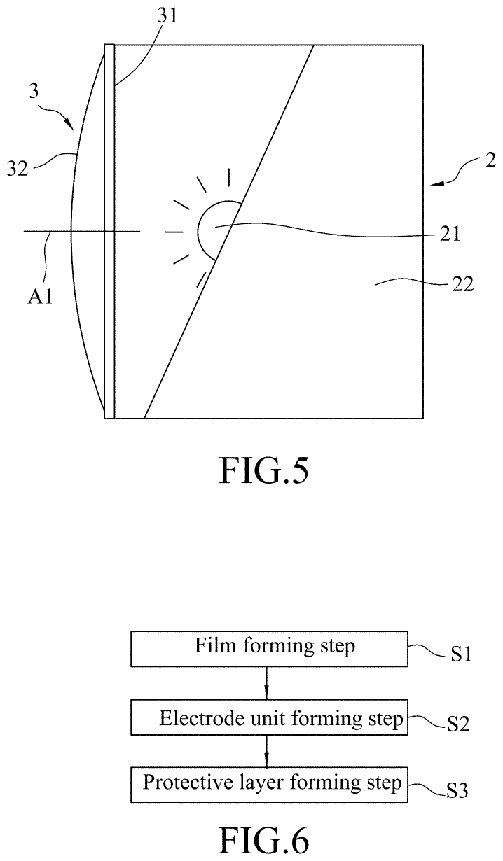

Referring to FIGS. 3 to 5, an embodiment of a lamp cover according to the disclosure is adapted for mounting in front of a light source 21 of a vehicle lamp 2. The vehicle lamp 2 has a lamp seat 22 for the light source 21 to be mounted on and has an optical axis (A1). The light source 21 projects light along the optical axis (A1).

The lamp cover includes a light-transmissible cover body 3, an electrically-conductive film 4 that is light-transmissible and that is formed on the cover body 3, an electrode unit 5 that is electrically connected to the electrically-conductive film 4, and a protective layer 6 that is disposed on the electrically-conductive film 4.

In this embodiment, the cover body 3 is transparent, but in other embodiments, the cover body 3 may be translucent and brown-, orange-, or red-tinted. The light-transmissible cover body 3 is convex relative to the lamp seat 22 of the vehicle lamp 2 and has a first surface 31 facing the lamp seat 22 and a second surface 32 opposite to the first surface 32. In this embodiment, both of the first and second surfaces 31, 32 are exemplified to be spherical surfaces. In one form, the first and second surfaces 31 may be parabola surfaces or other shapes. In this embodiment, the optical axis (A1) passes through a center of curvature of each of the first and second surfaces 31, 32.

The electrically-conductive film 4 is adapted for converting electrical energy provided by the electrode unit 5 into thermal energy to heat the light-transmissible cover body 3. In this embodiment, the electrically-conductive film 4 is made of indium tin oxide (ITO) and is formed on the first surface 31 of the cover body 3 using electron beam evaporation technique such as oxygen-assisted electron beam evaporation. The shape of the electrically-conductive film 4 corresponds with that of the first surface 31. In this embodiment, the electrically-conductive film 4 is transparent, but in other embodiments may be translucent and colored.

The electrically-conductive film 4 has a thickness ranging from 900 nanometers to 1100 nanometers. The electrically-conductive film 4 has a main film portion 41 adapted for the optical axis (A1) to pass therethrough, and an outer film portion 42 surrounding the main film portion 41. The outer film portion 42 is positioned corresponding to a section of the lamp seat 22 which surrounds the light source 21, has an outer film periphery 421 which is substantially circular and distal from the main film portion 41, and is formed with a current-blocking groove 422 extending therethrough.

The electrically-conductive film 4 has a sheet resistance ranging from 20 ohms per square to 85 ohms per square. In one form, the sheet resistance of the electrically-conductive film 4 ranges from 20 ohms per square to 36 ohms per square. In another form, the sheet resistance of the electrically-conductive film 4 ranges from 20 ohms per square to 25 ohms per square.

Moreover, the electrically-conductive film 4 has an average transmittance ranging from 64% to 81% in a wavelength range between 400 nanometers and 700 nanometers. In one form, the average transmittance of the electrically-conductive film 4 ranges from 77% to 80%.

The current-blocking groove 422 has a first groove section 423 extending along a first direction from the outer film portion 42 towards the optical axis A1, and a second groove section 424 extending along a second direction which is transverse to the first direction and intersecting the first groove section 423, forming a substantially “T” shape. Specifically, the electrically-conductive film 4 has an inner surface 43 adapted for facing the vehicle lamp 2 and an outer surface 44 that is opposite to the inner surface 43 and that is connected to the transparent cover body 3. The current-blocking groove 422 extends through the inner and outer surfaces 43, 44 of the electrically-conductive film 4. The first groove section 423 cooperates with the second groove section 424 and the outer film periphery 421 to define two current blocked regions 431 on the inner surface 43.

The electrode unit 5 is also formed using the electron beam evaporation technique on the electrically-conductive film 4. The electrode unit 5 includes two spaced-apart electrodes 51 disposed on the outer film portion 42. Each of the electrodes 51 is disposed inwardly of and extends along the outer film periphery 421, and is electrically connected to and provides current for the electrically-conductive film 4. Each of the electrodes 51 has an end 511 located within a respective one of the current blocked regions 431, another end 512 opposite to the end 511, and a connecting section 513 connecting the two ends 511, 512. The ends 511 of the electrodes 51 are connectable to a power supply for providing the current to the electrically-conductive film 4.

The protective layer 6 covers the electrically-conductive film 4 and the ends 512 and the connecting sections 513 of the electrodes 51, but not the ends 511 of the electrodes 51, and fills the current-blocking groove 422 by covering a portion of the first surface 31 of the cover body 3 corresponding to the current-blocking groove 422. The protective layer 6 is light transmissible. In this embodiment, the protective layer 6 is transparent and made of silicon dioxide, but, in other embodiments, may be translucent and may be made of titanium dioxide.

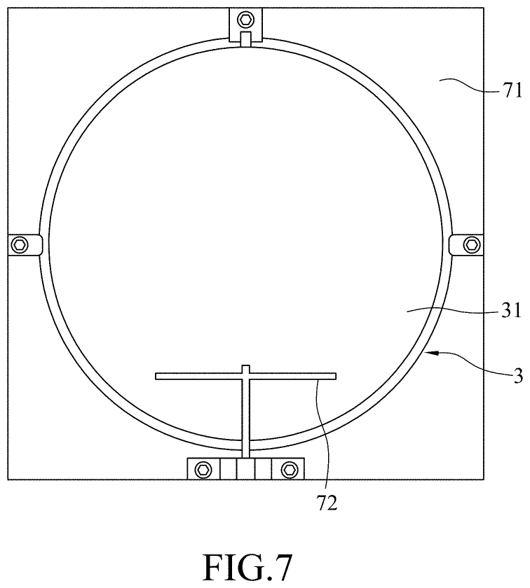

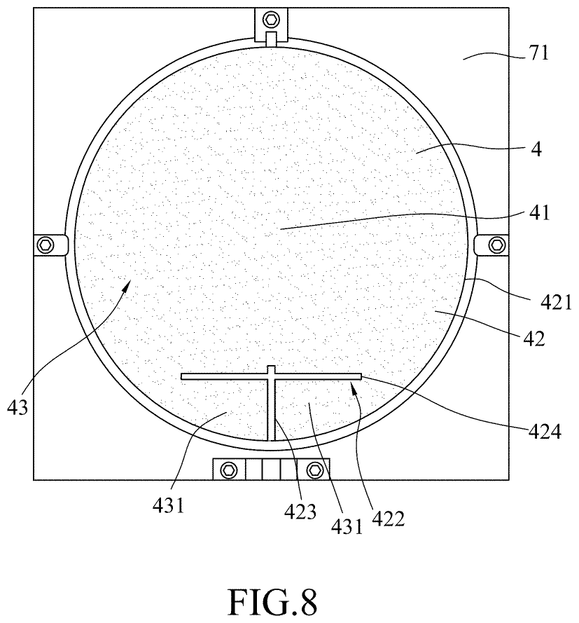

Referring to FIGS. 6 to 8, the embodiment of the lamp cover of the disclosure can be manufactured using a method as described below. The method of manufacturing the lamp cover includes a film forming step S1, an electrode unit forming step S2, and a protective layer forming step S3.

In the film forming step S1, first, the light-transmissible cover body 3, a metal mold 71 for the cover body 3 to be disposed in, and a first mask 72 disposed on the first surface 31 of the light-transmissible cover body 3 are provided. The metal mold 71 abuts against the second surface 32 of the cover body 3 for providing support to the cover body 3. The first mask 72 has a substantially T-shaped cross section and abuts against the first surface 31 so as to shield a portion of the first surface 31 from later evaporation plating.

Then, under a pressure of 3×10⁻⁵ torr and a temperature of 80° C., oxygen is induced at a flow rate of 13 standard cubic centimeters per minute (sccm) and electron beam evaporation is performed using indium tin oxide as a target at an evaporation rate of 6 angstroms per second. Once the evaporation plating process is complete, the first mask 72 is removed, and the electrically-conductive film 4 with the T-shaped current-blocking groove 422, which has the intersecting first and second groove sections 423, 424, is formed on the first surface 31 of the cover body 3. The two current blocked regions 431 defined by the first and second groove sections 423, 424 in cooperation with the outer film periphery 421 of the outer film portion 42 are also formed.

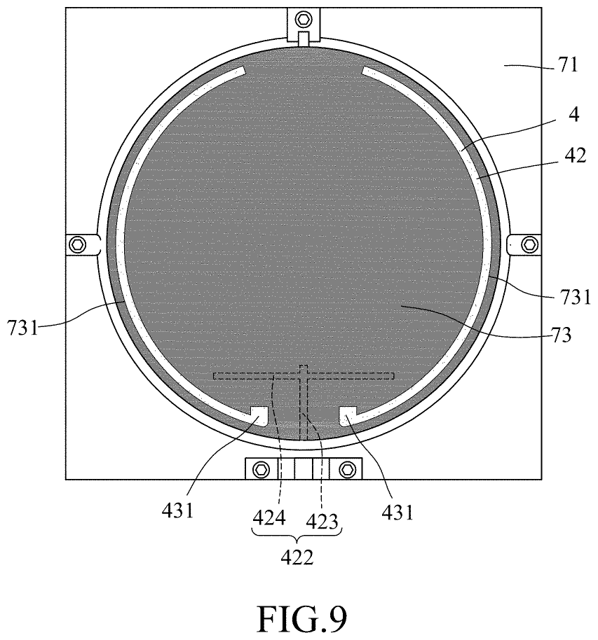

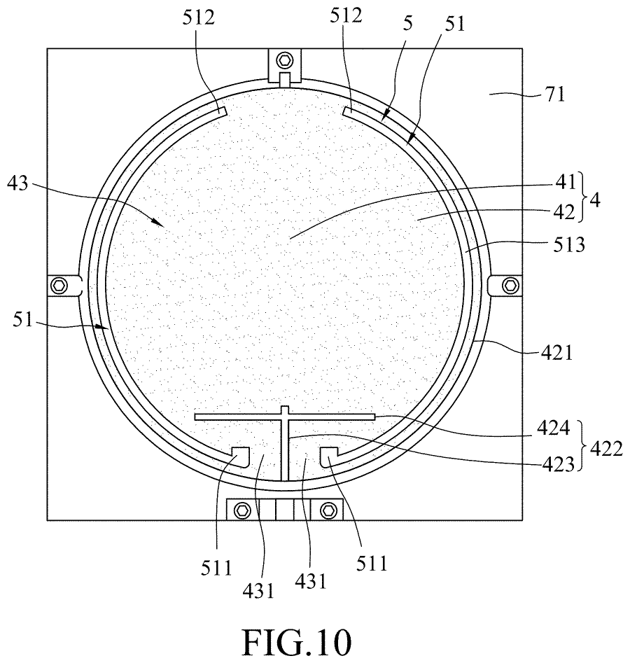

Referring to FIGS. 6, 9, and 10, in the electrode unit forming step S2, a second mask 73 covers over the electrically-conductive film 4 obtained from the step S1. The second mask 73 corresponds substantially in size with the electrically-conductive film 4, and is formed with two electrode grooves 731 that are spaced apart in the left-right direction, positioned inwardly of the outer film periphery 421 of the outer film portion 42, and extends along the outer film periphery 421 in a curved manner. Each of the electrodes 51 to be formed will correspond in position and shape to a respective one of the electrode grooves 731.

Then, under a pressure of 3×10⁻⁵ torr and a temperature of 60° C., electron beam evaporation is performed using aluminum as a target at the evaporation rate of 20 angstroms per second. Once the evaporation plating process is complete, the second mask 73 is removed, and the electrodes 51 on the electrically-conductive film 4 are formed.

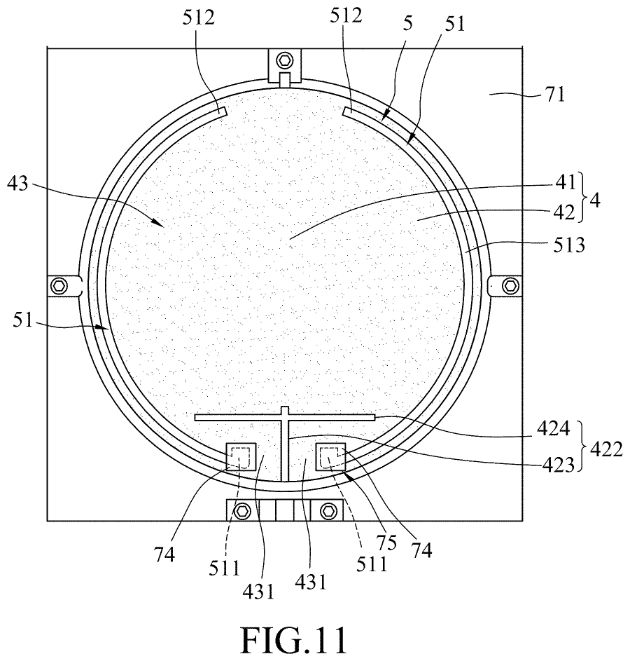

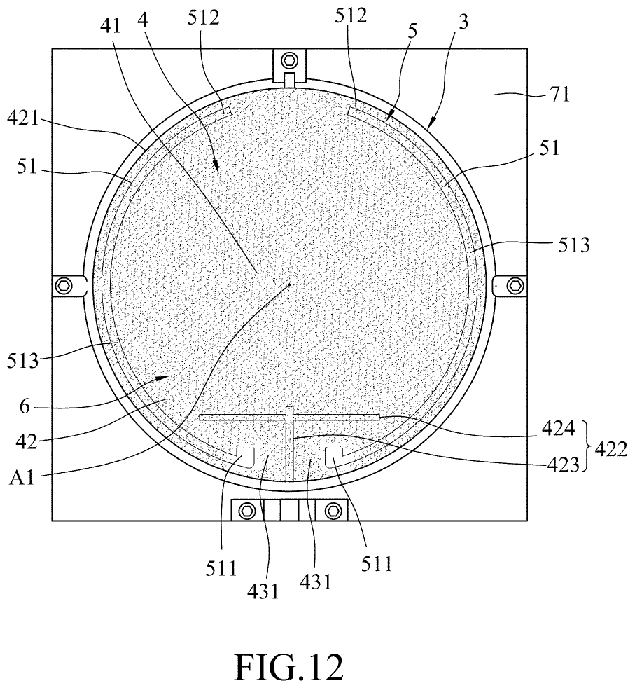

Referring to FIGS. 6, 11 and 12, in the protective layer forming step S3, first, a mask unit 75 including two third masks 74 is provided. The third masks 74 are used to respectively shield the ends 511 of the electrode unit 5. Then, under the conditions of a pressure of 3×10−5 torr and a temperature of 80° C., electron beam evaporation is performed using silicon dioxide as a target at an evaporation rate of 8 angstroms per second. Once the evaporation plating process is complete, the mask unit 75 is removed and the protective layer 6 covering the electrically-conductive film 4 and the electrode unit 5 excluding the ends 511 is formed.

In the following, Examples (EX.) 1 to 9 of the embodiment of the lamp cover of the disclosure are prepared based on the abovementioned method.

The flow rate of oxygen introduced for making each of EXs. 1 to 8, the thickness and sheet resistance of the electrically-conductive film 4 of each of EXs. 1 to 8, and the average transmittance of the cover body 3 and the electrically-conductive film 4 of each of EXs. 1 to 8 are summarized in Table 1.

TABLE 1

| | EX. 1 | EX. 2 | EX. 3 | EX. 4 | EX. 5 | EX. 6 | EX. 7 | EX. 8 |
|---|---|---|---|---|---|---|---|---|
| Flow rate of oxygen | 13 | 13 | 13 | 13 | 14 | 15 | 16 | 17 |
| (sccm) | | | | | | | | |
| Film Thickness | 900 | 600 | 680 | 1100 | 900 | 900 | 900 | 900 |
| (nm) | | | | | | | | |
| Sheet Resistance | 20 | 33 | 36 | 22 | 35 | 21 | 60 | 85 |
| (Ω/□) | | | | | | | | |
| Average Transmittance | 71.8 | 77.7 | 79.7 | 64.5 | 78.4 | 78.1 | 77.8 | 80.4 |
| (%) | | | | | | | | |

After forming the electrically-conductive film 4 of each of EXs. 1 to 8, a four-point probe apparatus is used to measure the sheet resistance of the electrically-conductive film 4 of each of EXs. 1 to 8. A spectrophotometer is also used to measure the average transmittance of the cover body 3 and the electrically-conductive film 4 in a wavelength range of 400 nanometers to 700 nanometers. Both the sheet resistance and the average transmittance measured for EXs. 1 to 8 are recorded in Table 1.

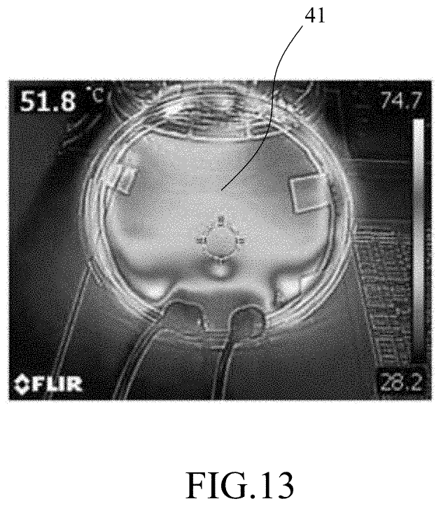

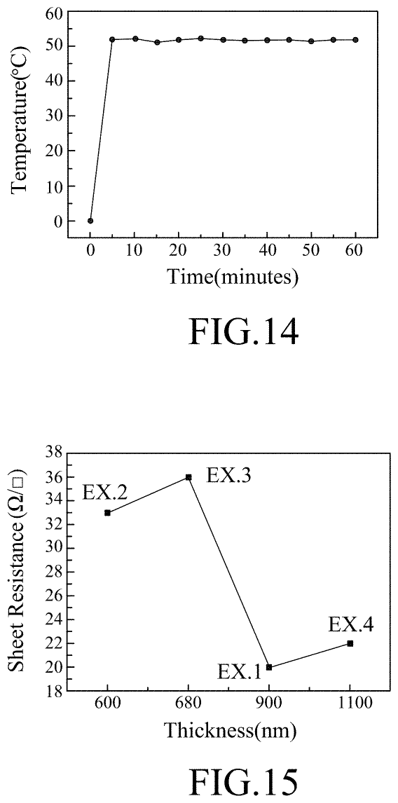

Furthermore, for Example 1, the electrode unit 5 is electrically connected to a 19.2-watt, 0.64-amp, and 30-volt power supply to provide a current to the electrically-conductive film 4, and a thermographic camera is used to capture a heat zone image, as in FIG. 13, every five minutes, in order to obtain the temperature of the main film portion 41. The temperature measured is plotted against time as in FIG. 14.

Moreover, the sheet resistance of the electrically-conductive layer 4 of each of EXs. 1 to 4 is plotted against the thickness as in FIG. 15.

As can be seen from FIGS. 13 and 14, when voltage is applied across the electrically-conductive film 4 of Example 1, the main film portion 41 of Example 1 exhibits an increase in temperature from 0° C. to 51.8° C. in five minutes. It is evident that any ice or snow accumulated on the cover body 3 of Example 1 can be effectively melted so that the light pattern emitted by the light source 21 is not affected. Furthermore, since the electrically-conductive film 4 is light-transmissible, it would also not affect the light pattern. Hence the lamp cover of the disclosure is applicable to be used with any pre-existing light source 21 without having to redesign or adjust the light source 21, reducing production or design costs.

As can be seen from FIG. 15 and Table 1, when the thickness of the electrically-conductive film 4 ranges from 600 nanometer to 680 nanometer, the sheet resistance increases with the thickness from approximately 33 ohms per square approximately 36 ohms per square. When the thickness increases to 900 nanometers, the sheet resistance decreases significantly to 20 ohms per square, then increases relatively more gradually as the thickness increases, for example being 22 ohms per square at a thickness of 1100 nanometers. On the other hand, as shown in Table 1, the average transmittance of the cover body 3 and the electrically-conductive film 4 generally decreases with increasing thickness.

By combining the equation for electric power P=IV, with Ohm's law, V=IR, one may obtain another equation for electric power, P=V²/R. From this equation it can be derived that under the same voltage, the lower the sheet resistance, the higher the electric power, and thus more heat can be provided for the cover body 3 in the same unit time for melting ice and snow accumulated thereon. From this equation along with FIG. 15, it can be seen that when the thickness of the electrically-conductive film is between 900 nanometer and 1100 nanometer under a fixed flow rate of oxygen, higher electrical power is obtained, and thus improved snow-melting effect can be obtained.

As can be seen from Table 1, with different flow rates of oxygen, the electrically-conductive films 4 thus formed would have different oxygen deficiencies, which result in different sheet resistances and transmittances. In general, under higher flow rates of oxygen, the electrically-conductive films 4 would be formed with less oxygen deficiencies, which increases the sheet resistance. However, even though sheet resistance increases when the flow rate of oxygen is increased from 13 sccm to 14 sccm, it decreases when the oxygen level is further raised to 15 sccm. When the flow rate of oxygen for assisting deposition in the film forming step S1 is at 15 sccm, the electrically-conductive film 4 formed would have a low sheet resistance, helping to achieve larger electric power, and the transmittance is also improved.

Furthermore, it can be seen that when the thickness of the film is 900 nanometers, the average transmittance of the cover body 3 and the electrically-conductive film 4 is favorable for light in the wavelength range of 400 nanometers to 700 nanometers, as in light of all wavelengths in this range may transmit well through the film. In addition, increasing the flow rate of oxygen during production also increases the average transmittance.

Example 9 is prepared in a manner similar to that of Example 1 except that the first mask 72 is omitted in the film forming step S1 so that the electrically-conductive film 4 is not formed with the current-blocking groove 422.

Comparing Example 1 and Example 9, as the electrically-conductive film 4 of Example 1 is formed with the current-blocking groove 422, current is prevented from passing through the direct, shortest route in the electrically-conductive film 4 and also from passing though the outer film portion 42 and skipping the main film portion 41. Specifically, because the electrically-conductive film 4 in Example 1 is formed with the current-blocking groove 422, the current is encouraged to pass through the main film portion 41 so to allow more efficient conversion of electrical energy to heat where light from the light source 21 passes through the cover body 3, accumulated snow and ice is removed and enhanced snow and ice melting effect is achieved as compared to Example 9 which omits the current-blocking groove 422.

For the lamp cover of the disclosure, each of the electrically-conductive film 4, the electrode unit 5 and the protective layer 6 are formed using electron beam evaporation technique, which not only improves structural compatibility, but also eliminates the need of using a glue with low thermal conductivity to join the electrically-conductive film 4 to the cover body 3, making the transfer of heat to the cover body 3 more efficient.

The electrodes 51 of the electrode unit 5 are disposed corresponding in position to the outer film portion 42. Since the outer film portion 42 do not interfere with the light pattern emitted by the light source 21, neither do the electrodes 51 interfere with the light pattern.

In this embodiment, each protective layer 6 not only protects the electrically-conductive layer 4 and the electrode unit 5, but, being made of silicon dioxide, can also reduce reflection to increase transmittance.

In sum, the lamp cover according to the disclosure uses a light-transmissible electrically-conductive film 4 to heat the cover body 3, which allows for the melting of ice and snow accumulated on the cover body 3 without affecting the light pattern of the light source 21. Thus, the lamp cover of the disclosure may be used with any pre-existing light sources without having to redesign or adjust the pre-existing light sources.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A lamp cover adapted for mounting to a vehicle lamp having an optical axis, said lamp cover comprising:
a light-transmissible cover body;
an electrically-conductive film being light-transmissible, and being formed on said cover body; and
an electrode unit being electrically connected to said electrically-conductive film;
wherein said electrically-conductive film is adapted for converting electrical energy provided by said electrode unit into thermal energy to heat said cover body.

2. The lamp cover as claimed in claim 1, wherein said electrically-conductive film is made of indium tin oxide.

3. The lamp cover as claimed in claim 1, wherein said electrically-conductive film has a main film portion adapted for the optical axis to pass therethrough, and an outer film portion surrounding said main film portion, said outer film portion being formed with a current-blocking groove extending therethrough.

4. The lamp cover as claimed in claim 3, wherein said current-blocking groove has a first groove section extending along a first direction from said outer film portion towards the optical axis, and a second groove section extending along a second direction transverse to the first direction and intersecting said first groove section.

5. The lamp cover as claimed in claim 4, wherein:
said outer film portion has an outer film periphery distal from said main film portion; and
said electrode unit includes two spaced-apart electrodes disposed on said outer film portion, each of said electrodes being disposed inwardly of said outer film periphery and extending along said outer film periphery.

6. The lamp cover as claimed in claim 5, wherein:
said electrically-conductive film has an inner surface adapted for facing the vehicle lamp and an outer surface that is opposite to said inner surface and that is connected to said light-transmissible cover body, said current-blocking groove extending through said inner and outer surfaces of said electrically-conductive film;
said first groove section cooperates with said second groove section and said outer film periphery to define two current blocked regions on said inner surface of said electrically-conductive film; and
each of said electrodes has an end located within a respective one of said current blocked regions.

7. The lamp cover as claimed in claim 1, further comprising a protective layer covering said electrically-conductive film and said electrode unit.

8. The lamp cover as claimed in claim 7, wherein said protective layer is light-transmissible and is made of silicon dioxide.

9. The lamp cover as claimed claim 1, wherein said electrically-conductive film is formed on said cover body using electron beam evaporation technique.

10. The lamp cover as claimed in claim 1, wherein said electrically-conductive film has a thickness ranging from 900 nanometers to 1100 nanometers.

11. The lamp cover as claimed in claim 1, wherein said electrically-conductive film in combination with said light-transmissible cover body has an average transmittance ranging from 64% to 81% in a wavelength range of 400 nanometers to 700 nanometers.

12. The lamp cover as claimed in claim 11, wherein the average transmittance of said electrically-conductive film ranges from 77% to 80%.

13. The lamp cover as claimed in claim 11, wherein the average transmittance of said electrically-conductive film in combination with said light-transmissible cover body is 78.1%.

14. The lamp cover as claimed in claim 1, wherein said electrically-conductive film has a sheet resistance ranging from 20 ohms per square to 85 ohms per square.

15. The lamp cover as claimed in claim 14, wherein the sheet resistance of said electrically-conductive film ranging from 20 ohms per square to 36 ohms per square.

16. The lamp cover as claimed in claim 14, wherein the sheet resistance of said electrically-conductive film ranging from 20 ohms per square to 25 ohms per square.
